(19) United States
(12) Patent Application Publication
(10) Pub. No.: US 2025/0355631 A1
(43) Pub. Date: Nov. 20, 2025

(54) AUTOMATED REPAIR OF CODE GENERATION PROMPT

(71) Applicant: BUSINESS OBJECTS SOFTWARE LTD, DUBLIN (IE)

(72) Inventor: Paul O'HARA, Dublin (IE)

(21) Appl. No.: 18/665,961

(22) Filed: May 16, 2024

(51) Int. Cl. G06F 8/30

(52) U.S. Cl. CPC G06F 8/30

(57) ABSTRACT

Systems and methods include input of a code generation prompt to a text generation model, reception of code from the text generation model in response to the input code generation prompt, execution of the received code, determination of execution information associated with the execution of the received code, input of a repair prompt, the code generation prompt and the execution information to the text generation model, and reception of an updated code generation prompt from the text generation model in response to the input repair prompt, code generation prompt and execution information.

### BACKGROUND

Generative AI-assisted workflows are increasingly used across a range of industries. One use case finding increased adoption is automated code generation. Using generative AI for code generation may provide increased development speed, accuracy, and standardization, as well as decreased errors and debugging time. Code generated via generative AI should leverage applicable frameworks and should be syntactically correct, error-free, logically correct, and optimized.

Automatic generation of desired code is initiated by providing a prompt to a generative AI system. The prompt provides specific instructions intended to guide an underlying text generation model to generate the code. The prompt may specify desired functionality, behavior, and structure of the code, along with any inputs which may be provided to the model. The quality of the generated code is directly related to the sufficiency of the prompt.

Crafting a prompt which is suitable for code generation is challenging. Although a user may understand the steps of the functions to be executed by the code, it is often difficult to translate these steps into a prompt which causes a model to repeatedly generate syntactically correct, error-free, logically correct, and optimized code. This difficulty is exacerbated by the lack of transparency as to how a model generates code based on a prompt, thereby preventing a user from informedly modifying a prompt to reduce issues within code generated in response to the prompt. Consequently, updating a prompt to address issues in the code generated thereby is iterative, labor-intensive, and non-trivial.

Systems are desired to efficiently generate code generation prompts which result in generation of code suitable for various scenarios.

### BRIEF DESCRIPTION OF THE DRAWINGS

FIG. 1 is a block diagram of an architecture to repair a code generation prompt according to some embodiments.

FIGS. 2A and 2B comprise a flow diagram of a process to repair a code generation prompt according to some embodiments.

FIG. 3 is a user interface for creating a code generation prompt and initiating an analysis thereof according to some embodiments.

FIG. 4 illustrates generation of an execution item representing an execution of code generated by a text generation model in response to a code generation prompt according to some embodiments.

FIG. 5 illustrates clustering of execution of execution items according to some embodiments.

FIG. 6 illustrates generation of a code repair prompt based on a template, an execution item of a candidate cluster, and a code generation prompt according to some embodiments.

FIG. 7 is a user interface presenting a code generation prompt generated according to some embodiments.

FIG. 8 is a block diagram of a hardware environment providing analysis and repair of a code generation prompt according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Some embodiments provide a framework for automating repair of a code generation prompt. Briefly, a code generation prompt is provided to a text generation model (e.g., a Large Language Model (LLM)) several times to cause generation of several samples of executable code. The code generation prompt may be a system prompt and may be accompanied by a user prompt which provides input data specified in the code generation prompt. The generated code samples are executed and information representing any execution errors is collected. An embedding is generated for each code sample based on its execution information. The embeddings are clustered, and one of the clusters is identified as representing a candidate execution error on which subsequent repair of the prompt will be focused.

A repair prompt is generated which instructs the model to identify portions of the code generation prompt which caused the candidate execution error and to output an updated code generation prompt which corrects the identified portions. The repair prompt may specify inputs including the original code generation prompt, generated code associated with the candidate execution error, and the information associated with the execution error. The repair prompt and a user prompt providing the inputs are transmitted to the model and an updated code generation prompt is received in return.

The updated code generation prompt is utilized to generate code as described above, and the process repeats until a stopping heuristic indicates that the latest updated code generation prompt is stable. Stability of a code generation prompt may indicate that any code which is generated utilizing the code generation prompt will execute the tasks specified therein successfully and without error.

By automatically identifying and addressing flaws within a user-defined code generation prompt, embodiments may efficiently provide the ability to generate code which executes specified tasks successfully and without error. Embodiments advantageously reduce the need for users to tediously and repetitively update a code generation prompt until the prompt can be reliably used to generate suitable code. Some embodiments therefore enable a user with minimal coding knowledge to generate high-quality code and are suitable for low-code/no-code frameworks.

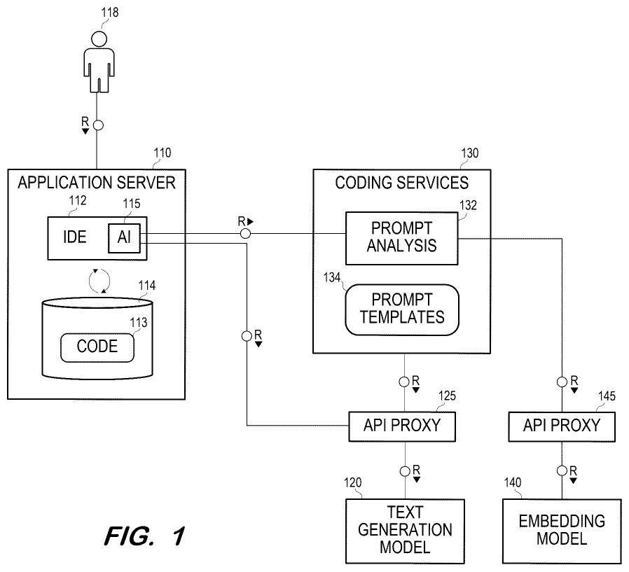

FIG. 1 is a block diagram of an architecture to repair a code generation prompt according to some embodiments. Each of the illustrated components may be implemented using any suitable combination of on-premise, cloud-based, distributed (e.g., including distributed storage and/or compute nodes) computing hardware and/or software that is or becomes known. Each computing system described herein may comprise one or more physical and/or virtualized servers.

Two or more components of FIG. 1 may be co-located. In some embodiments, two or more components are implemented by a single computing device. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Application server 110 may comprise one or more servers, virtual machines, clusters of a container orchestration system, etc. Application server 110 may provide an operating system, services, I/O, storage, libraries, frameworks, etc. to applications executing therein, such as integrated development environment (IDE) 112. Application server 110 may execute other unshown applications in addition to IDE 112.

IDE 112 may comprise program code executable by a processing unit to provide code development functions to users such as user 118. Generally, IDE 112 may facilitate the development of executable code conforming to a given programming language by providing editing, compiling and debugging functions as is known in the art. Embodiments are not limited to any programming language or type of IDE.

Code 113 may include code developed using IDE 112 and/or other code. Code 113 is stored in data store 114, which may comprise any suitable storage system such as a database system. Data store 114 may be located partially or fully remote from application server 110, and may be distributed as is known in the art.

IDE 112 includes AI assistant component 115 according to some embodiments. AI assistant component 115 may provide an interface for leveraging generative AI-based tools. These tools may include automated code generation tools. For example, user 118 may access IDE 112 via a Web browser executing a front-end user interface (UI) application associated with IDE 112. User 118 may use a UI of IDE 112 to generate a prompt which requests generation of code having specific characteristics.

IDE 112 may then use AI assistant component 115 to transmit a code generation prompt to text generation model 120 via Application Programming Interface (API) proxy 125 as is known in the art. Text generation model 120 may comprise a neural network trained to generate text based on input text. Trained text generation model 120 may be implemented by, for example, executable program code, a set of hyperparameters defining a model structure and a set of corresponding weights, or any other representation of an input-to-output mapping which was learned as a result of the training.

According to some embodiments, model 120 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 120 include GPT-4, LaMDA, and Claude. Model 120 may be publicly available or deployed within a landscape which is trusted by a provider of application server 110. Similarly, text generation model 120 may be trained based on public and/or private data.

Text generation model 120 generates code in response to the code generation prompt and a user prompt received from AI assistant component 115. AI assistant component 115 receives the generated code, which may be modified by user 118 and/or stored in code 113.

According to some embodiments, user 118 may also operate IDE 112 to request analysis of the user-generated code generation prompt. AI assistant component 115 may transmit the request and the prompt to prompt analysis component 132 of coding services 130. Coding services 130 may be implemented by one or more on-premise or cloud-based servers. Prompt analysis component 132 operates in conjunction with prompt templates 134, text generation model 120 and embedding model 140 as described below to analyze the prompt and, if needed, generate and return an updated code generation prompt to IDE 112.

In one example, prompt analysis component 132 provides the code generation prompt and a user prompt to text generation model 120 to cause generation of code. Prompt analysis component 132 executes the code and, if the execution is not successful, determines information associated with the execution. The execution information may include, for example, an exception type, an exception message, the line of code which caused the exception, and/or M (e.g., M=5) lines of code preceding the line of code which caused the exception. Prompt analysis component 132 transmits the execution information to embedding model 140 via API proxy 145 and receives an embedding (i.e., a multi-dimensional numerical vector representing the error information) in return. If the code was successfully executed, execution information indicating a successful execution type and empty values for the exception message and lines of code is transmitted to embedding model 140 to generate a corresponding embedding.

Prompt analysis component 132 repeats the foregoing steps N (e.g., N=10) times, resulting in N instances of generated code and a corresponding embedding. Prompt analysis component 132 determines an execution item for each code instance, consisting of the code, the corresponding execution information and the corresponding embedding. The embeddings are clustered using any suitable clustering algorithm that is or becomes known, including but not limited to a cosine similarity-based clustering algorithm. The cluster including the most embeddings is then identified as representing a candidate execution error on which subsequent updating of the code generation prompt will be focused.

Prompt analysis component 132 generates a repair prompt based on a repair prompt template of templates 134. The repair prompt may include instructions to identify portions of the code generation prompt which caused the candidate execution error and to output an updated code generation prompt which corrects the identified portions. Prompt analysis component 132 may also generate a user prompt providing the original code generation prompt and an execution item associated with an embedding of the identified cluster. Prompt analysis component 132 transmits the repair prompt and user prompt to text generation model 120 and receives an updated code generation prompt in return.

A stopping heuristic is evaluated to determine whether the updated code generation prompt is stable. If so, the updated code generation prompt is returned to IDE 112. If not, the process repeats using the updated code generation prompt as input.

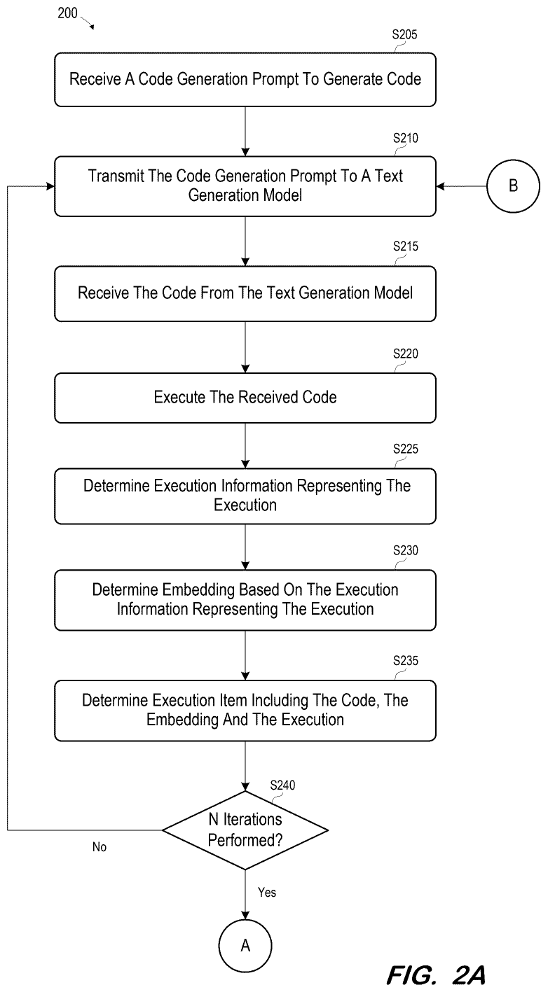

FIGS. 2A and 2B comprise a flow diagram of process 200 to repair a code generation prompt according to some embodiments. Process 200 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

A code generation prompt is received at S205. The code generation prompt is intended to prompt a text generation model to generate code. For example, the code generation prompt may specify the specific task(s) to be accomplished by the code, a programming language to which the code should conform, any constraints, placeholders or variables to be replaced with actual data or information, a desired code structure, and/or examples of input data and expected output. Embodiments are not limited to any particular tasks, programing languages, constraints, variables, code structure or input.

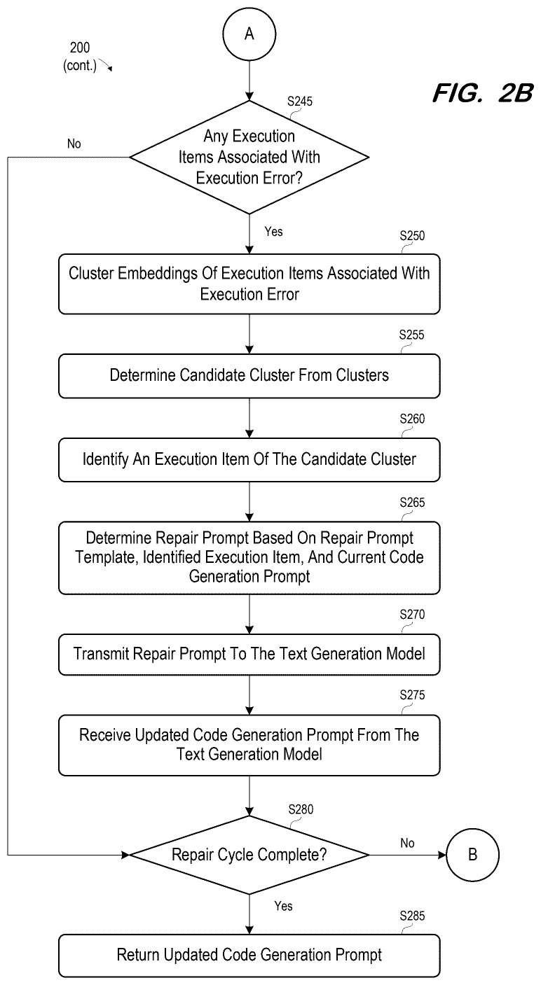

The code generation prompt may be received at S205 along with a corresponding user prompt providing input data indicated by the placeholders or variables on which the code will operate and a request to analyze the code generation prompt. The request may be triggered by a user via a user interface. FIG. 3 illustrates user interface 300 of an IDE according to some embodiments. In one example, user 118 executes a Web browser to access IDE 112 via HyperText Transfer Protocol and receives user interface 300 in return.

User interface 300 includes area 310 for inputting a code generation prompt. The code generation prompt may include any suitable text and may be inputted manually, via cut-and-paste, and/or via any other input modality. The code generation prompt may include input data or placeholders for such input data to be provided by a corresponding user prompt.

Interface 300 includes Generate Code control 320. Generate Code control 320 is selectable to initiate transmission of the code generation prompt to a text generation model and to receive code in return. For example, selection of control 320 may cause AI assistant component 115 of IDE 112 to transmit the code generation prompt and a user prompt directly to text generation model 120 for generation of corresponding code.

Analyze Prompt control 330 is selectable to initiate analysis and possible repair of the code generation prompt. In one example, user 118 selects Analyze Prompt control 330 and thereby causes AI assistant component 115 to transmit a request including the code generation prompt to prompt analysis component 132, which receives the request and the code generation prompt at S205. Embodiments are not limited to user interface 300. Embodiments may utilize any interface metaphor for creating a code generation prompt and for requesting analysis and repair thereof.

The code generation prompt is transmitted to a text generation model at S210. It is assumed that the text generation model operates as trained to generate code based on the code generation prompt and any inputs provided by an optional user prompt. The code is received from the text generation model at S215.

The received code is executed at S220. Any execution environment may be used to execute the code at S220, and execution may comprise compiling and linking the code into an executable in some embodiments. Execution of the code results in either a successful execution or an execution which causes an exception to be thrown. In either case, execution information representing the execution is determined at S225.

If the execution was not successful, the execution information may include fields such as an indication that the execution was not successful (e.g., a False flag), an exception type, an exception message, the line of code which caused the exception, and several lines of code preceding the line of code which caused the exception. The determined execution information may be formatted as a series of text strings separated by commas or another delimiter, where each text string represents one of the above fields (e.g., [F, <exception type>, <exception message>, <line of code which caused the exception>, <lines of code preceding the line of code which caused the exception>]). If the execution was successful, the execution information may include an indication that the execution was successful (e.g., a True flag) followed by a series of commas representing empty fields (e.g., [T , , , , ]).

An embedding is determined at S230 based on the determined execution information. The embedding may be determined by transmitting the execution information to an embedding model and receiving an embedding in return. Next, at S235, an execution item is determined which includes the code received at S215, an indication of whether the execution at S220 was successful (e.g., Tor F), and the corresponding embedding determined at S230.

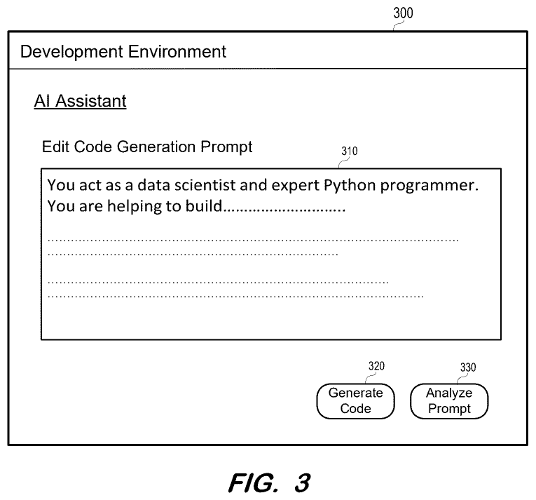

FIG. 4 illustrates S205 through S235 according to some embodiments. Accordingly, FIG. 4 depicts an example of generation of an execution item based on the execution of code generated by a text generation model in response to a code generation prompt.

Code generation prompt 410 is received by prompt analysis component 420 at S205. Prompt analysis component 420 provides code generation prompt 410 to text generation model 430 at S210 to cause generation of code 440. Code execution environment 422 executes code 440 at S215, resulting in generation of execution information 424. A user prompt may accompany code generation prompt 410 to provide inputs specified therein as is known in the art.

Execution item creation component 426 determines text string vector 428 including elements of execution information 424 and transmits vector 428 to embedding model 450. In response, embedding model 450 generates and returns embedding 455 to execution item creation component 426. Execution item creation component 426 determines execution item 460 at S235. Execution item 460 corresponds to code 440 and prompt 410 and includes code 440, an indication of whether the execution of code 440 was successful, and embedding 455.

Returning to process 200, it is determined at S240 whether N iterations of S210-S235 have been performed with respect to the current code generation prompt. N may be any predefined and/or heuristically-determined value. If N iterations of S210-S235 have not yet been performed, flow returns to S210 to perform another iteration until N iterations have been performed.

Despite the use of a same code generation prompt at each of the N iterations, it is assumed that different code is generated by and received from the text generation model at each iteration of S215. Accordingly, the execution at S220, the execution information determined at S225, and the embedding determined at S230 may differ among the iterations. Each of the N iterations may therefore result in and be associated with a different execution item at S235. In some embodiments, two or more of the execution items determined at different iterations of S235 may be identical.

Flow proceeds from S240 to S245 after N iterations of S210 through S235 have been performed. At S245, it is determined whether any of the N execution items is associated with an execution error. S245 may comprise determining whether the execution information of any of the N execution items indicates an execution error. If not, then all of the execution items are assumed to be associated with successful executions and flow proceeds to S280. Flow proceeds from S245 to S250 if it is determined that one or more of the N execution items is associated with an execution error.

The embeddings of the one or more execution items associated with an execution error are clustered at S250. The embeddings are clustered using any suitable clustering algorithm that is or becomes known. For example, the cosine similarity algorithm determines the similarity between two vectors by measuring the cosine of the angle between the two vectors. The cosine similarity may range from 1 to −1, where the values closer to 1 indicate greater similarity. According to some embodiments, any two embeddings having a cosine similarity equal to or greater than 0.95 are determined to belong to the same cluster at S250.

The cluster including the greatest number of embeddings is determined as a candidate cluster at S255. The embeddings of the candidate cluster represent an execution error on which subsequent repair of the code generation prompt will be focused. An execution item associated with an embedding of the candidate cluster is identified at S260.

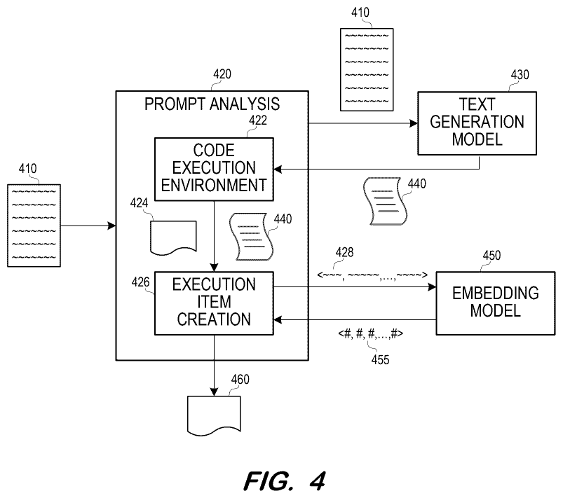

FIG. 5 illustrates identification of an execution item associated with a candidate cluster of embeddings according to some embodiments. Execution items 460-469 have been determined at different iterations of S235 and each of execution items 460-469 is associated with an unsuccessful execution. Clustering algorithm 510 determines the embeddings of each of execution items 460-469 and executes a clustering algorithm to determine clusters consisting of the embeddings.

The present example shows three clusters 520, 522, 524 determined at S250. Cluster 520 includes three embeddings, cluster 522 includes two embeddings, and cluster 524 includes five embeddings. Cluster 524 is therefore determined to be the candidate cluster at S255.

The shaded embedding of cluster 524 is selected and its corresponding execution item 462 is identified at S260. The selection of an embedding from the candidate cluster may be random, particularly in implementations where a high degree of similarity exists between embeddings of a cluster.

A repair prompt is determined at S265. The repair prompt may be a repair prompt template which includes placeholders for the exception type of the execution item identified at S260, the exception message of the identified execution item, the code causing the exception, the current code generation prompt, and the generated code associated with the execution item. S265 may include substitution of the placeholders of the repair prompt template with the information or generation of a corresponding user prompt including the information.

According to some embodiments, the repair prompt includes instructions to consider the code generation prompt and the generated code to summarize the tasks of the code generation prompt. Based on the task summary, the generated code, the exception type, the exception message, and the code causing the exception, an error analysis is to be performed to identify tasks of the task summary that could have caused the code causing the exception to be generated. Next, sections of the code generation prompt to which the identified tasks are related are identified.

The repair prompt may further include instructions to update the code generation prompt to correct the identified sections. The instructions may specify types of corrections which are permitted, such as rephrasing, adding clarifying text, and appending code examples related to the identified tasks. The repair prompt is transmitted to the text generation model at S270, and an updated code generation prompt is received from the text generation model at S275.

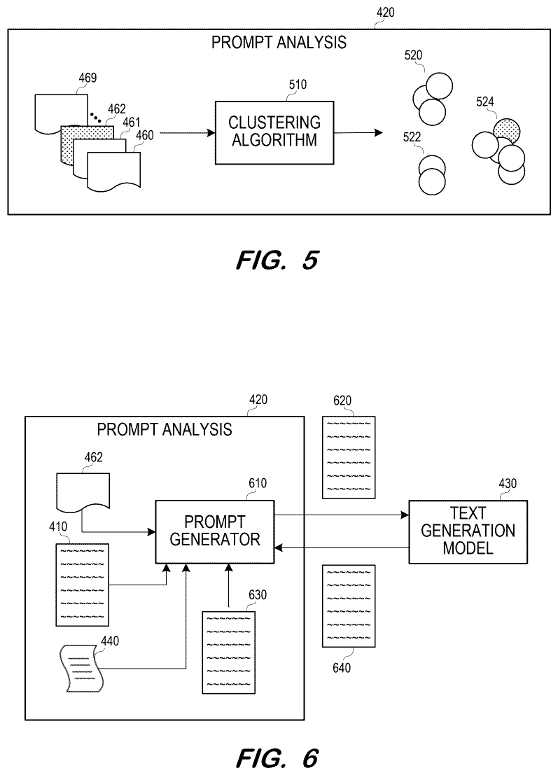

FIG. 6 illustrates S265 to S275 according to some embodiments. As shown, prompt generator 610 generates repair prompt 620 at S265 based on repair prompt template 630, identified execution item 462 of FIG. 5, and code generation prompt 410 and generated code 440 of FIG. 4. A user prompt may accompany repair prompt 620 to provide inputs specified therein. Repair prompt 620 is transmitted to text generation model 430 at S270, and updated code generation prompt 640 is received from text generation model 430 at S275.

A stopping heuristic is evaluated at S280 to determine whether the repair cycle is complete. If so, the updated code generation prompt is returned to the analysis requestor (e.g., IDE 112) at S285. If not, flow returns to S210 to repeat the above process using the updated code generation prompt as the code generation prompt. The initial code generation prompt may thereby undergo incremental changes until the repair cycle is complete.

According to some embodiments, the determination of whether the repair cycle is complete comprises determination of whether the updated code generation prompt received at S275 is stable. To determine stability, an internal counter is maintained of the number of consecutive iterations of S210-S275 in which no exceptions occurred during execution of generated code at S220. For example, the counter is incremented by 1 each time the determination at S245 is No and is reset to 0 each time the determination at S245 is Yes. The internal counter is inspected at S280 to determine whether it exceeds a predefined threshold. If so, the updated code generation prompt is considered stable, and the repair cycle is deemed complete at S280. If the internal counter does not exceed the predefined threshold, flow returns from S280 to S210 as described above.

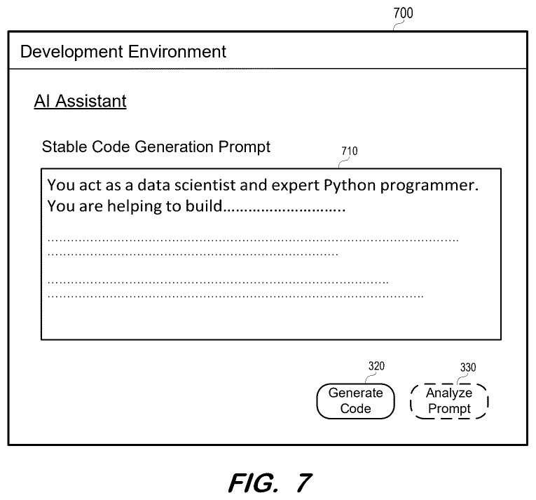

FIG. 7 illustrates UI 700 of an IDE for presenting an updated code generation prompt according to some embodiments. Area 710 presents the updated code generation prompt and control 320 may be selected to initiate code generation using the prompt. In some embodiments, a user may modify the prompt displayed in area 710. Once a modification occurs, control 330 may become selectable to initiate execution of process 200 with respect to the modified updated code generation prompt.

The following is an example of a user-generated code generation prompt according to some embodiments, along with a user prompt for providing the inputs mentioned in the code generation prompt.

### Code Generation Prompt:

“You act as a data scientist and expert Python programmer. You are helping to build a binary classification model by using the XGBoost algorithm.

You are to generate a Python function to finish the task, Machine Learning Modelling and Interpretation, referred to as MLMI.

As part of the MLMI task you will have access to the raw data the analysis is to be performed on, available in memory as a pandas dataframe named localdata.

The generated function will take three parameters:
localdata: the raw data
target_col: the name of the target variable
exclude_cols: list of excluded columns, this is optional, default value should be an empty list

In the generated function, complete the following modelling tasks:

Modelling 1. Using localdata, extract a list of column names.

Modelling 2. Transform all non-numeric variables within localdata using LabelEncoder to numeric labels, then, convert the numeric labels to string.

Modelling 3. If target_col is non-numeric, transform it using LabelEncoder to numeric labels, then convert the numeric labels to string.

Modelling 4. Build a XGBoost classification model, based on the Input variables and Target variable defined below. All data will be used here. Do not split the data into training, validating datasets.
Target variable: The specified target column, target_col. Please use it as the target variable in the XGBoost model.
Input variables: Use the columns-excluding the columns referenced within exclude_cols, and target variable, target_col—to form a separated list as the input variables in the XGBoost model.

Modelling 5. Exclude the target variable, target_col, from the Input variables list.

Modelling 6. Apply the trained XGBoost model on the same dataset to predict the target.

Modelling 7. Compare the predicted target values with the true target values to generate a report in terms of accuracy.

Modelling 8. Use the permutation_importance function to extract the feature importance of all input variables based on feature permutation.

Modelling 9. Plot the extracted feature importance in a bar chart.

As the next step, after finishing the above modelling tasks, complete the following interpretation tasks:

Interpretation 1. Create a Tree Explainer for the trained XGBoost model using SHAP package.

Interpretation 2. Use the Tree Explainer to explain the predictions for the records with the original ‘Yes’ target value by plotting the summary.

Interpretation 3. Identify the top input variable that mostly impacts on the target for the records with the original ‘Yes’ target value, named as ‘top_var’. Plot the effect this top input variable has on the predictions made by the model, select and pass a random sub-sample of rows to the plot function.

Interpretation 4. From the plot, identify which input variable most closely relates to the identified top variable, named as \′re_var\′.

Interpretation 5. Print out the ‘top_var’ and ‘re_var’.

Interpretation 6. Plot the impacts of the input variables on the target for every record with the original \′Yes\′ target value.

Interpretation 7. Define the matrix of SHAP values of all the records with the original \′Yes\′ target value as SHAP Matrix.

We need to further investigate the derived SHAP Matrix with the following tasks:

Interpretation 8. Use PCA to get the first two principals of this SHAP Matrix. Plot the first two principals by using Scatter plot with marker size 5.

Interpretation 9. Use Kmeans algorithm to group the Shap rows in this SHAP Matrix into 3 clusters. Identify the SHAP row that is closest to the center of each cluster.

Interpretation 10. Given each of the identified SHAP rows, use decision plot to show how the trained XGBoost classification model makes decision to reach the prediction.

Use Numpy library for mathematical calculation in python code.

Once the function is generated, call it.

Generate the python code now.”

### User Prompt for Code Generation Prompt:

$$“ exclude\_cols = \{ 0 \} , target\_col = \{ 1 \} ”$$

The following is an example of a repair prompt according to some embodiments, along with a user prompt for providing the inputs specified in the repair prompt.

### Repair Prompt:

“You are an expert prompt engineer and expert in python. You are skilled at exploiting large language models through prompts to generate code.

Your role is to assist in the diagnosis and repair of a large language model prompt used to generate python code. The generated python code, when executed produced an exception.

You will be given by the user:
in_prompt: prompt used to generate the python code that when executed, produced an exception
gen_code: the generated python code output as a response to the prompt
exception_type: the type of exception thrown the code was executed
exception_message: the exception message produced
exception_code: the line of generated code causing the exception

Perform the following four steps:

1. Consider in_prompt, gen_code.
Summarize the purpose of the prompt.
Explain your reasoning step by step to be sure you are correct.
Prefix the output prompt summary with <prompt_task_summary> and suffix with </prompt_task_summary>

2. Consider prompt task summary, gen_code, exception_type, exception_message, and exception_code.
Perform an error analysis, highlighting any tasks within the prompt task summary that could have caused the code producing the error to be generated.
Explain your reasoning step by step to be sure you are correct.
Prefix the output error analysis with <error_analysis> and suffix with </error_analysis>

3. Consider in_prompt, prompt task summary, gen_code, exception_type, exception_message, exception_code, and error analysis.
If error analysis identified potential tasks that could cause code producing the error to be generated, return the section of in_prompt the task is related to
Explain your reasoning step by step to be sure you are correct.
Prefix the section with <prompt_flaws>, and suffix with </prompt_flaws>.

4. Consider in_prompt, prompt task summary, gen_code, exception_type, exception_message, exception_code, error analysis, identified prompt flaws.
Update in_prompt correcting the identified prompt flaws causing the code producing the error to be generated. As part of the update, you can:
Update in_prompt rephrasing the wording of in_prompt
Update in_prompt adding additional lines or text clarifying
Append in_prompt adding code examples to the end of the prompt
Output the entire updated input prompt, prefixed with <updated_prompt> and suffixed with </updated_prompt>.”

### User Prompt for Repair Prompt:

“###Input ###
in_prompt: {0}
gen_code: “′python {1} \\\
exception_type: {2}
exception_message: {3}
exception_code: {4}”

The following is an updated code generation prompt generated by a text generation model based on the above code generation prompt and repair prompt according to some embodiments.

### Updated Code Generation Prompt:

“You act as a data scientist and expert Python programmer. You are helping to build a binary classification model by using the XGBoost algorithm.

You are to generate a Python function to finish the task, Machine Learning Modelling and Interpretation, referred to as MLMI.

As part of the MLMI task you will have access to the raw data the analysis is to be performed on, available in memory as a pandas dataframe named localdata.

The generated function will take three parameters:
localdata: the raw data
target_col: the name of the target variable
exclude_cols: list of excluded columns, this is optional, default value should be an empty list

In the generated function, complete the following modelling tasks:

Modelling 1. Using localdata, extract a list of column names.

Modelling 2. Transform all non-numeric variables within localdata, excluding the target column, using LabelEncoder to numeric labels.

Modelling 3. If target_col is non-numeric, transform it separately using LabelEncoder to numeric labels. Make sure to not transform it again after this step.

Modelling 4. Build a XGBoost classification model, based on the Input variables and Target variable defined below. All data will be used here. Do not split the data into training, validating datasets.
Target variable: The specified target column, target_col. Please use it as the target variable in the XGBoost model.
Input variables: Use the columns-excluding the columns referenced within exclude_cols, and target variable, target_col—to form a separated list as the input variables in the XGBoost model.

Modelling 5. Exclude the target variable, target_col, from the Input variables list.

Modelling 6. Apply the trained XGBoost model on the same dataset to predict the target.

Modelling 7. Compare the predicted target values with the true target values to generate a report in terms of accuracy.

Modelling 8. Use the permutation_importance function to extract the feature importance of all input variables based on feature permutation.

Modelling 9. Plot the extracted feature importance in a bar chart.

As the next step, after finishing the above modelling tasks, complete the following interpretation tasks:

Interpretation 1. Create a Tree Explainer for the trained XGBoost model using SHAP package.

Interpretation 2. Use the Tree Explainer to explain the predictions for the records with the original target value by plotting the summary.

Interpretation 3. Identify the index of the top input variable that mostly impacts on the target for the records with the original target value, named as ‘top_var_index’. Plot the effect this top input variable has on the predictions made by the model using the ‘shap.dependence_plot’ function. Please note that the ‘shap.dependence_plot’ function requires the index of the variable, not the variable name.

Interpretation 4. From the plot, identify which input variable most closely relates to the identified top variable, named as ‘re_var’. This should be the variable that has the highest average SHAP value when considering the SHAP values for each variable across all records. Please note that the index of the maximum SHAP value should not be used to directly index the list of column names. Instead, calculate the average SHAP value for each input variable, find the variable with the highest average SHAP value, and assign its name to ‘re_var’.

Interpretation 5. Print out the ‘top_var’ and ‘re_var’.

Interpretation 6. Plot the impacts of the input variables on the target for every record with the original target value.

Interpretation 7. Define the matrix of SHAP values of all the records with the original target value as SHAP Matrix.

Interpretation 8. Use PCA to get the first two principals of this SHAP Matrix. Plot the first two principals by using Scatter plot with marker size 5.

Interpretation 9. Use Kmeans algorithm to group the Shap rows in this SHAP Matrix into 3 clusters. Identify the SHAP row that is closest to the center of each cluster. To find the closest rows, use the ‘pairwise_distances_argmin_min’ function from the sklearn.metrics.pairwise module.

Interpretation 10. Given each of the identified SHAP rows, use decision plot to show how the trained XGBoost classification model makes decision to reach the prediction. Please note that the ‘feature_names’ argument in the ‘shap.decision_plot’ function requires a list or numpy array, not a pandas Index object.

Use Numpy library for mathematical calculation in python code. Make sure to import it before using it in the code.

Once the function is generated, call it.

Generate the python code now.

Note: The generated code should be valid Python syntax and should not include commands that are specific to a Jupyter notebook or similar environment, such as “!pip install”.”

### User Prompt for Updated Code Generation Prompt:

$$“ exclude\_cols = \{ 0 \} , target\_col = \{ 1 \} ”$$

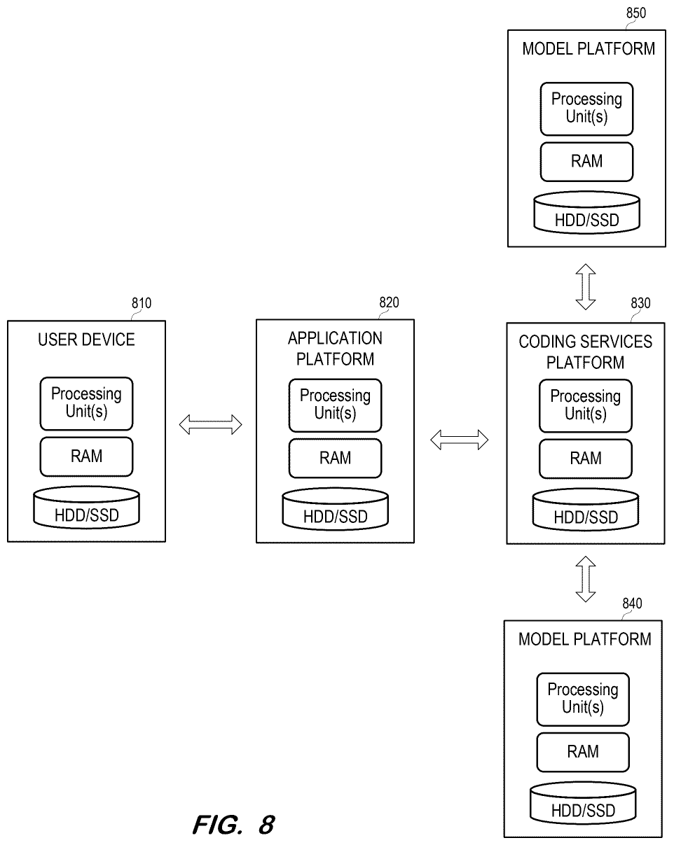

FIG. 8 is a block diagram of a cloud-based system according to some embodiments. Application platform 820, coding services platform 830 and model platform 840, 850 may each comprise cloud-based resources, such as virtual machines, allocated by a cloud provider providing self-service and immediate provisioning, autoscaling, security, compliance and identity management features.

User device 810 may interact with a user interface of an application executing on application platform 820, for example via a Web browser executing on user device 810. The user interface may receive a request to analyze a code generation prompt. Application platform 820 may forward the request to a coding service executing on coding services platform 830. The coding service may operate as described herein in conjunction with a text generation model executing on model platform 840 and an embedding model executing on model platform 850 to generate an updated code generation prompt. The updated code generation prompt is then returned to user device 810 for display thereon.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing program code; and
one or more processing units to execute the program code to cause the system to:
receive a code generation prompt;
a) input the code generation prompt to a text generation model;
b) receive code from the text generation model in response to the input code generation prompt;
c) execute the received code;
d) determine execution information associated with the execution of the received code;
e) determine an embedding based on the execution information;
repeat a) through e) a plurality of times to determine a plurality of embeddings;
determine a plurality of clusters of embeddings based on similarities between the plurality of embeddings, each of the plurality of embeddings associated with only one of the clusters;
determine one of the plurality of clusters;
determine one of the embeddings associated with the determined cluster;
input a repair prompt, the code generation prompt and execution information based on which the determined one embedding was determined to the text generation model; and
receive an updated code generation prompt from the text generation model in response to the input repair prompt, code generation prompt and execution information.

2. The system of claim 1, wherein the execution information input to the text generation model includes a name of an exception and an exception message.

3. The system of claim 2, wherein the execution information associated with execution of received code includes one or more lines of the received code which caused the exception.

4. The system according to claim 1, wherein the determined one of the plurality of clusters is the one of the plurality of clusters associated with a greatest number of embeddings.

5. The system of claim 1, the one or more processing units to execute the program code to cause the system to:
f) input the updated code generation prompt to the text generation model;
g) receive updated code from the text generation model in response to the input updated code generation prompt;
h) execute the received updated code;
i) determine updated execution information associated with the execution of the updated received code;
j) determine an updated embedding based on the updated execution information;
repeat f) through j) a plurality of times to determine a plurality of updated embeddings;
determine a second plurality of clusters of updated embeddings based on similarities between the plurality of updated embeddings, each of the plurality of updated embeddings associated with only one of the second plurality of clusters;
determine one of the second plurality of clusters;
determine one of the updated embeddings associated with the determined one of the second plurality of clusters;
input the repair prompt, the updated code generation prompt and updated execution information based on which the determined one of the updated embeddings was determined to the text generation model; and
receive a second updated code generation prompt from the text generation model in response to the input repair prompt, updated code generation prompt and updated execution information.

6. The system of claim 5, wherein the execution information input to the text generation model includes a name of an exception and an exception message, and
wherein the updated execution information input to the text generation model includes a second name of a second exception and a second exception message.

7. The system of claim 6, wherein the execution information associated with execution of received code includes one or more lines of the received code which caused the exception, and
wherein the updated execution information associated with execution of received updated code includes one or more lines of the received updated code which caused the second exception.

8. A method comprising:
inputting a code generation prompt to a text generation model;
receiving code from the text generation model in response to the input code generation prompt;
executing the received code;
determining execution information associated with the execution of the received code;
inputting a repair prompt, the code generation prompt and the execution information to the text generation model; and
receiving an updated code generation prompt from the text generation model in response to the input repair prompt, code generation prompt and execution information.

9. The method of claim 8, wherein the execution information input to the text generation model includes a name of an exception and an exception message.

10. The method of claim 9, wherein the execution information associated with execution of received code includes one or more lines of the received code which caused the exception.

11. The method of claim 8, further comprising:
inputting the code generation prompt to the text generation model a plurality of times;
receiving code from the text generation model in response to each input of the code generation prompt to the text generation model;
executing each of the plurality of received code;
for each execution of the plurality of received code, determining associated execution information;
determining an embedding based on each associated execution information;
determining a plurality of clusters of embeddings based on similarities between each embedding, each embedding associated with only one of the plurality of clusters;
determining one of the plurality of clusters associated with a greatest number of embeddings;
determining a candidate embedding associated with the determined one of the plurality of clusters; and
determining to input to the text generation model the execution information based on which the candidate embedding was determined.

12. The method of claim 8, further comprising:
inputting the updated code generation prompt to the text generation model;
receiving updated code from the text generation model in response to the input updated code generation prompt;
executing the received updated code;
determining updated execution information associated with the execution of the received updated code;
inputting the repair prompt, the updated code generation prompt and the updated execution information to the text generation model; and
receiving a second updated code generation prompt from the text generation model in response to the input repair prompt, updated code generation prompt and updated execution information.

13. The method of claim 12, wherein the execution information input to the text generation model includes a name of an exception and an exception message, and
wherein the updated execution information input to the text generation model includes a second name of a second exception and a second exception message.

14. The method of claim 13, wherein the execution information associated with execution of received code includes one or more lines of the received code which caused the exception, and
wherein the updated execution information associated with execution of received updated code includes one or more lines of the received updated code which caused the second exception.

15. A non-transitory medium storing program code executable by one or more processing units of a computing system to cause the computing system to:
a) input a code generation prompt to a text generation model;
b) receive code from the text generation model in response to the input code generation prompt;
c) execute the received code;
d) determine execution information associated with the execution of the received code;
e) determine an embedding based on the execution information;
repeat a) through e) a plurality of times to determine a plurality of embeddings, each of the plurality of embeddings associated with an instance of received code and execution information associated with execution of the instance of received code;
determine a plurality of clusters of embeddings based on similarities between the plurality of embeddings, each of the plurality of embeddings associated with only one of the clusters;
determine one of the plurality of clusters representing an error;
determine one of the embeddings associated with the determined cluster;
input a repair prompt, the code generation prompt and execution information associated with the determined one embedding to the text generation model; and
receive an updated code generation prompt from the text generation model in response to the input repair prompt, code generation prompt and execution information.

16. The medium of claim 15, wherein the execution information input to the text generation model includes a name of an exception and an exception message.

17. The medium of claim 16, wherein the execution information associated with execution of received code includes one or more lines of the received code which caused the exception.

18. The medium according to claim 15, wherein the determined one of the plurality of clusters is the one of the plurality of clusters associated with a greatest number of embeddings.

19. The medium of claim 15, the program code executable by one or more processing units of a computing system to cause the computing system to:
f) input the updated code generation prompt to the text generation model;
g) receive updated code from the text generation model in response to the input updated code generation prompt;
h) execute the received updated code;
i) determine updated execution information associated with the execution of the updated received code;
j) determine an updated embedding based on the updated execution information;
repeat f) through j) a plurality of times to determine a plurality of updated embeddings, each of the plurality of updated embeddings associated with an instance of received updated code and updated execution information associated with execution of the instance of received updated code;
determine a second plurality of clusters of updated embeddings based on similarities between the plurality of updated embeddings, each of the plurality of updated embeddings associated with only one of the second plurality of clusters;
determine one of the second plurality of clusters associated with a second error;
determine one of the updated embeddings associated with the determined one of the second plurality of clusters;
input the repair prompt, the updated code generation prompt and updated execution information associated with the determined one of the updated embeddings to the text generation model; and
receive a second updated code generation prompt from the text generation model in response to the input repair prompt, updated code generation prompt and updated execution information.

20. The medium of claim 19, wherein the execution information input to the text generation model includes a name of an exception and an exception message,
wherein the updated execution information input to the text generation model includes a second name of a second exception and a second exception message,
wherein the execution information associated with execution of received code includes one or more lines of the received code which caused the exception, and
wherein the updated execution information associated with execution of received updated code includes one or more lines of the received updated code which caused the second exception.
